(19) United States
(12) Patent Application Publication
(10) Pub. No.: US 2013/0106610 A1
(43) Pub. Date: May 2, 2013

(54) Sentnel Surveillance System With Pre-Alarms To Avert Drowning

(71) Applicant: Norman Frederick Pratt, Scottsdale, AZ (US)

(72) Inventor: Norman Frederick Pratt, Scottsdale, AZ (US)

(21) Appl. No.: 13/664,958

(22) Filed: Oct. 31, 2012

Related U.S. Application Data
(60) Provisional application No. 61/628,431, filed on Nov. 1, 2011.

(51) Int. Cl. G08B 21/08

(52) U.S. Cl. 340/573.6

(57) ABSTRACT

A surveillance system to prevent drowning comprised of day and night compatible wireless video camera and/or cameras and other sensors, which monitor and detect the presence of an individual and its progression through selected zones of increasing danger as he or she approaches a body of water. The output of these sensors are input to data processing system which analyzes the inputs and transmits control signals to various pre-selected alarms that are commensurate to danger zones thereby enabling corrective action to be initiated well in advance of a drowning or impending accident.

### BACKGROUND OF THE INVENTION

I claim an effective filing data on this patent application of Nov. 1, 2010, in keeping with provisional patent 61/628,431 entitled SENTNEL. This invention relates to a method and apparatus for the prevention of pool drowning. More specifically, the invention relates to system of providing warnings commensurate to the degree of danger as an individual approaches the swimming pool through distinct zones of increasing danger surrounding and encompassing the pool. These alarms are activated well in advance of an individual being submerged, thereby providing more timely response to any emergency.

Statistics indicate that a considerable advantage would be gained by providing timely warnings. Some of these startling statistics are as follows.

The National Safety Council reported that each year, an estimated 5000 children ages 14 and under are hospitalized due to unintentional drowning incidents, 15% die in the hospital, and as many as 20% suffer permanent neurological disabilities.

The CDC in 2005-2006 reported that in 2004 of all children 1-4 years old who died, succumbed from drowning. Fatal drowning was the second leading cause of unintentional injury reported deaths of children in age groups 1-14.

Orange County, California Fire Authority, reported that a swimming pool is 14 times more likely than a motor vehicle to be involved in the death of a child 4 and under. They also reported that of all preschoolers who drown, 70% are in the care of one or both parents at the time of drowning and 75% are missing out of sight for only 5 minutes or less.

In the United States, a total annual cost of drowning related deaths among children ages 14 and under is over $800 million, to say nothing of the millions spent on care of those that survive, besides the agony and stress that is experienced from such a tragedy.

The need for a system that will provide several warning levels prior to a catastrophic accident is critically required. It is the intent of this system to provide such a tool, thus preventing a majority of accidents from occurring and providing a better chance of survival with minimal complications.

### SUMMARY OF INVENTION

The object of this invention to provide a system with which a plurality of pre-warnings, commensurate with the level of anticipated danger, are activated as an individual approaches the pool and upon being submerged. This will be accomplished by a system, which will monitor the presence of an individual as they enter, and exit established zones of preserved danger around the perimeter of the pool. The monitored progress will then activate warning devices, which will be commensurate to the level of danger preserved.

The detection of an individual's presence will be accomplished in a variety of ways dependent on the specific challenges presented. The devices used could be any or all of the following: video cameras, infrared, magnetic, optical and radio frequency sensors monitoring the individual as he or she approaches the pool. These sensors in turn activate any number of alarms thus allowing time for corrective action to be taken to avert an accident.

### DISCUSSION OF INVENTION

The invention presented herein addresses such needs by increasing the time response to an impending accident. The following is an example of the system methodology; it is presented as an example of its operation but in no means should it be construed as placing any limits on its potential.

There are four categories in this example; these are sensing, analyzing, control and alarm.

The sensing category consists of infrared and/or magnetic sensors, which monitor the gate in the fence that surrounds the pool. The sensor is activated when the gate is opened and an individual enters the cool deck area. This occurrence is confirmed by the day and night compatible infrared wireless video camera or cameras, which are used to monitor the pool and surrounding area. All wireless transmissions are encrypted to assure security. As the individual proceeds toward the pool and progresses through various defined zones of increasing danger surrounding the pool, these events are captured by the camera or cameras and wirelessly transmitted to data processing system (DPS). This DPS, then analyzes the input signals noting the progress of the individual through the various zones of danger. Upon completing this analysis, the DPS will wirelessly communicate its commands to control system specifying the actions that should be taken. The controller will then activate the appropriate alarms, commensurate to the danger preserved. These wireless communications take place over a secured system to minimize miscommunication.

Assuming there are three specific zones of danger surrounding the pool, the corresponding alarms could be as follows:

Zone (1) in this example, it is defined as an area beyond the fence and prior to the cool deck. Upon detecting an intrusion, simultaneously the surrounding area and pool lights would be turn on; an acoustical (verbal or siren) alarm within and surrounding the residence, lights in selected areas would blink or specific lights would automatically be turned on.

The Zone (2) this area is defined in this example as the cool deck surrounding the pool. All of the alarms mentioned in Zone (1) would remain activated. Additional alarms would be activated as well. Wired and wireless telephones would be called announcing a pre-recorded warning. A text message would also be initiated to pre-established phones. A radio would then be automatically turn on and tuned to a pre-selected frequency where a warning broadcast would be initiated within legally restricted areas, carrying a warning of what is occurring.

Zone (3) is defined as anywhere within the boundaries of the swimming pool. All previous alarms would remain activated if no preventive action has been taken.

Assuming those who are in charge are still distracted by a loud television program, the television channel would be changed and a display of the sensing video camera will be displayed along with a pre-recorded warning.

The zone designations and alarm examples given are a small sample of what can be achieved using a data processing system coupled with a control system utilizing the ZigBee RF4CE technology or equivalent.

Current drowning prevention patents do not embody this methodology. U.S. Pat. No. 7,677,940 Nazarian; Rez: Mar. 16, 2010 embodies a safety apparatus, which is worn around an individual's waist and is selectively inflated by a handle and compressed gas. U.S. Pat. No. 6,064,309 Sellers; Scott et al: May 16, 2000 embodies a safety system wearable by a individual such that a radio frequency transmitter is activated sending a signal to a microprocessor receiving station within its range, activating alarms. U.S. Pat. No. 5,619,187 Serfontein; Marius P.: Apr. 18, 1997 embodies a sensor that is worn by an individual such that when submerged in water a transmitter is activated to sound an alarm. U.S. Pat. No. 5,274,359 Adams; Bruce: Dec. 28, 1993 embodies a portable water activated alert system utilizing a radio frequency transmitter and receiver to activate an alarm. All four of these patents rely on an individual being equipped with a device on his or her body or clothing and assumes the device is not removed or forgotten to be attached rendering it incapable of functioning as intended. U.S. Pat. No. 6,691,334 St-Hilaire; Stephane: Feb. 17, 2004 embodies a swimming pool cover as prevention.

### REFERENCES CITED

### U.S. Patent Documents

| | | |
|---|---|---|
| 7,677,940 | March 2010 | Nazarian |
| 6,691,334 | February 2004 | St-Hilaire |
| 6,064,309 | May 2000 | Seller |
| 5,619,187 | April 1997 | Serfontein |
| 5,274,359 | December 1993 | Adams |

What is claimed is:

1) A method and apparatus to prevent drowning, where in a plurality of increasing danger zones are established around the perimeter of a body of water such that as an individual approaches the body of water; their progress is detected and monitored by a variety of sensors. It also provides a data processing system programmed to analyze the data and initiating commands as to what precautionary actions should be initiated; a control unit to activate the commensurate actions; and a plurality of alarm systems of all types. All communication between the systems is achieved over a wireless encrypted system to ensure security.

2) A method and apparatus as in claim (1), in which all zones of increasing danger can be customized to satisfy all the unique requirements of a project.

3) A method and apparatus as in claim (1), whereby the sensors utilized in any given application can be designated to assure the specific requirements of a project.

4) A method and apparatus as in claim (1), whereby both controls and alarms can be configured to fulfill the requirements of a project.
